(19) United States
(12) Patent Application Publication
(10) Pub. No.: US 2014/0369398 A1
(43) Pub. Date: Dec. 18, 2014

(54) DIGITAL FILTER, PARTIAL RESPONSE EQUALIZER, AND DIGITAL COHERENT RECEIVER DEVICE AND METHOD

(71) Applicant: ZTE (USA) Inc., Richardson, TX (US)

(72) Inventors: Jianjun Yu, Basking Ridge, NJ (US); Jianqiang Li, Morristown, NJ (US)

(73) Assignee: ZTE (USA) Inc., Richardson, TX (US)

(21) Appl. No.: 14/369,886

(22) PCT Filed: Dec. 19, 2012
(86) PCT No.: PCT/US2012/070533

§ 371 Date: Jun. 30, 2014

Related U.S. Application Data
(60) Provisional application No. 61/581,946, filed on Dec. 30, 2011.

(51) Int. Cl. H04L 25/03; H04L 27/38

(52) U.S. Cl. CPC H04L 25/03012; H04L 27/38
USPC 375/232

(57) ABSTRACT

Aspects of the present invention include devices and methods for receiving signals in communication systems. A partial response equalizer includes a full response linear equalizing device for equalizing a received signal; and a partial response post filter for post filtering the equalized signal. Aspects of the present invention devices and methods for coherently receiving signals in an optical communication system. A receiver front end converts a received partial response optical signal to a partial response digital signal. An equalizing device equalizes the pre-filtered full response digital signal. A full response carrier recovery device performs carrier recovery of the signal equalized by the equalizing device. A post-filter filters the signal having undergone carrier recovery by the full response carrier recovery device.

### FIELD OF THE INVENTION

The field of the present invention is communication systems, and particularly, digital filters, partial response equalizers, and coherent receiver devices and methods.

The ever increasing bandwidth demand has been driving communication systems to higher capacities. Therefore, there is a strong motivation to enhance spectral efficiency to increase the total capacity. From a spectral-multiplexing point of view, there are several approaches for improving the spectral efficiency given a specified modulation format. One straightforward approach is to realize bandwidth-constraint on individual multiplexed channels by narrowband filtering. By this means, the spectrum is squeezed and high spectral-efficiency can be achieved. However, the inter-symbol interference (ISI)-free condition cannot be maintained since the equivalent channel in the presence of narrowband filtering would have strong ISI with a long memory. Moreover, the ISI pattern (i.e. the channel impulse response) is commonly unknown and unconditioned, which necessitates complicated channel estimations. Partial-response equalization may be a good solution for this kind of system. A partial-response equalizer is capable of shaping the unknown channel impulse response into a known partial-response class (e.g. duobinary). Slight performance loss may occur as long as the channel response is similar to the target partial-response (D. D. Falconer and F. R. Magee, Jr., “Adaptive channel memory truncation for maximum-likelihood sequence estimation,” Bell System Tech. J., vol. 52, no, 9, pp. 1541-1562, November 1973.). Unlike the widely-studied full-response equalizers, the reported partial-response equalizers are almost in the decision-directed or decision-feedback modes. The devise of feedforward partial-response equalizers may be desirable in particular for coherent optical communication systems. Fields of the present invention are not limited to optical communication systems.

Recently, the coherent detection coupled with digital signal processing (DSP) has been well recognized as the crucial technologies for 100 G and beyond optical communication systems, as described by P. J. Winzer in “Beyond 100 G Ethernet,” IEEE Commun. Mag., vol. 48, no. 7, pp. 26-30, 2010, and S. J, Savory in “Digital Coherent Optical Receivers: Algorithms and Subsystems,” IEEE J. Sel. Top. Quantum Electron., vol. 16, no. 5, pp. 1164-1179, September/October 2010, in a digital optical coherent receiver, most of the linear transmission impairments can be compensated for by the digital linear equalizers. The linear equalizers can provide a convenient and low-complexity way to perform polarization demultiplexing and to compensate for several time-varying impairments in an adaptive manner, as described by S. J. Savory In “Digital Coherent Optical Receivers: Algorithms and Subsystems,” IEEE J. Sel. Top. Quantum Electron., vol. 16, no. 5, pp. 1164-1179, September/October 2010. The ever-reported diverse linear equalizers are almost full-response ones that are suitable to small-ISI channels. A linear equalizer yields good performance on the channels with well-behaved spectral characteristics (i.e. small ISI), whereas it may not be a desirable option in the presence of severe ISI due to the noise enhancement effect as described by J. G. Proakis in “Digital Communications, Fourth Edition”, New York: McGraw-Hill, 2001. In addition, a number of other full-response DSPs have also been developed in the optical communication community, it is strongly desired to preserve these full-response equalizers and other corresponding DSPs without modifications. The present invention can address the above issues.

Another concern is about the implementation complexity in practice. Among various partial response classes, duobinary is attractive because it can in theory tailor the spectrum into a Nyquist band with one-symbol memory. Duobinay response is described here and in other parts as an example for convenience of understanding. Any other partial response classes can also be used, for example, class 2, class 3, modified duobinary, extended class 4, and class 6 etc., according to the specific channel Impulse responses in the systems to be investigated. Due to the short memory of the target duobinary response, the MLSD complexity is dramatically reduced with respect to “Transmission of 96×100-Gb/s bandwidth-constrained PDM-RZ-QPSK channels with 300% spectral efficiency over 10610 km and 400% spectral efficiency over 4370 km,” J. Lightw. Technol., vol. 29, no. 4, pp. 491-498, February 2011 by J.-X. Cal, C. R. Davidson, D. G. Foursa, A. J. Lucero, O. V. Sinkin, W. W. Patterson, A. N. Pilipetskii, G. Mohs, and N. S. Bergano, “20 Tbit/s capacity transmission over 6,860 km,” in Proc. OFC2011, March 2011, Paper PDPB4” by J.-X. Cal, Y. Cal, C. R. Davidson, A. Lucero, H. Zhang, D. G. Foursa, O. V. Sinkin, W. W. Patterson, A. Pilipetskii, G. Mohs, and N. S. Bergano, and “Spectrum-narrowing tolerant 171-Gbit/s PDM-16QAM transmission over 1,200 km using maximum likelihood sequence estimation,” in Proc. ECOC 2011, September 2011, Paper We. 10. P1.73.

### SUMMARY OF THE INVENTION

Aspects of the present invention Include devices and methods for receiving signals in communication systems. In one aspect, a partial response equalizer includes a full response linear equalizing device for equalizing a received signal; and a partial response post filter for post filtering the equalized signal.

In another aspect of the present invention, a receiver front end converts a received partial response optical signal to a partial response digital signal. An equalizing device equalizes the pre-filtered full response digital signal. A full response carrier recovery device performs carrier recovery of the signal equalized by the equalizing device. A post-filter filters the signal having underbone carrier recovery by the full response carrier recovery device.

### BRIEF DESCRIPTION OF THE DRAWINGS

FIG. 1 illustrates a schematic diagram of a partial response equalizer.

FIG. 2 illustrates an example of a filter model used for implementation.

FIG. 3 illustrates a schematic diagram of a partial-response equalizer with a carrier recovering device.

FIG. 4 illustrates a schematic diagram Illustrating a complete receiving method for optical communication systems.

FIG. 5 illustrates a model of a spectrally-shaped QAM system.

FIGS. 6(a) and (b) are illustrations of trellises for M-ary PAM for M=2 and 4.

FIG. 7 illustrates a simplified model of a duobinary channel.

### DETAILED DESCRIPTION OF EMBODIMENTS

Aspects of the present invention relate to digital filters, partial response equalization, digital coherent receiver devices, and digital coherent receiver methods. They protect coherent receiving methods for polarization-multiplexed systems, mode-multiplexed systems, space-multiplexed systems, and the like. These aspects decrease complexity from existing technologies while providing the same, or better, level of performance. Aspects allow for the use of conventional DSP algorithms originally developed for full-response signals. Also, aspects of the invention provide a simple but high-sensitivity coherent receiving method for bandwidth-constraint signals. Further, aspects of the invention are powerful in spectrally-efficient WDM optical communication systems.

Aspects of the present invention may be implemented in various scenarios, three of which are:
1) general synchronous communication systems where full-response linear equalizers introduce strong noise or linear crosstalk enhancement;
2) communication systems where phase noise is a problem to be taken into account; and
3) coherent receiving methods for optical communication systems including several conventional DSP devices.

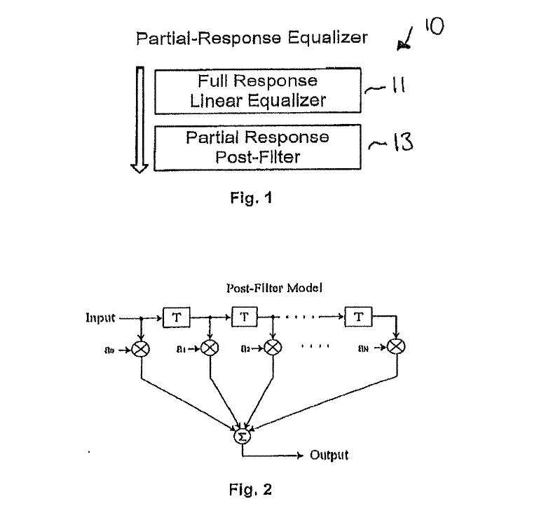

FIG. 1 illustrates a schematics diagram of a partial response equalizer 10. A post filter 13 is digital, and is placed after a full response linear equalizer 11 in a feedforward manner. The combination of these two devices performs the function of partial response equalization. The full response linear equalizer 11 may be any type that can equalize the input signal with ISI into an ISI-free signal. The frequency response of the partial response post-filter is expected to be similar to the channel response with respect to its shape. Furthermore, the impulse response of the partial response post-filter is expected to be a known response and its length N should be finite. FIG. 2 illustrates an example of a filter model used for implementation. The structure in FIG. 2 determines the target partial response type. The tap coefficients can be arbitrary, and meanwhile the tap number can be arbitrary. Duobinary is a special example when there are two taps in FIG. 2. The corresponding tap coefficients are both ones.

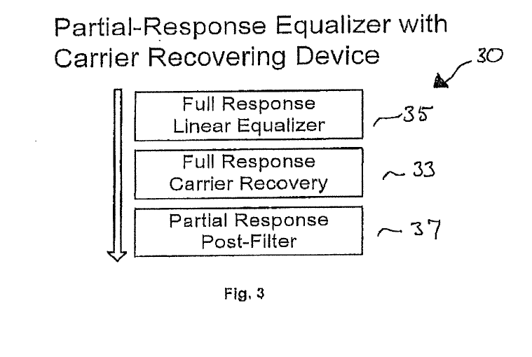

FIG. 3 is a schematic diagram of the second case illustrating a partial-response equalizer 30 with a carrier recovering device 33. The feedforward structure of this equalizer allows it to easily use full-response carrier recovery methods. The carrier recovering device may be placed between the full response linear equalizer 35 and the post-filter 37.

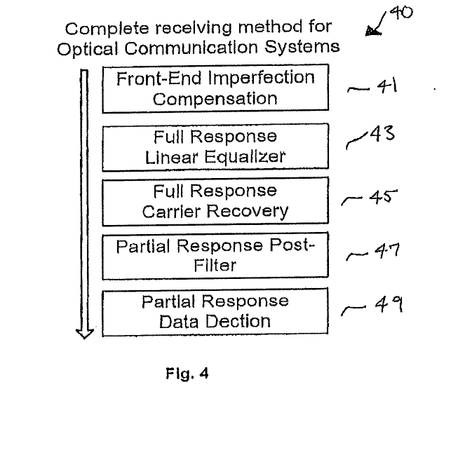

FIG. 4 is a schematic diagram of the third case illustrating a coherent digital receiver 40, which includes front-end imperfection compensation 41, a full response linear equalizer 43, a full response carrier recovering device 45, a partial response post-filter 47, and a partial response data detection device 49. Because the signal will be equalized into a signal with a partial response, the data detection device 49 can be any type of known detector for partial-response signals. By way of non-limiting example only, the detector may be a symbol-by-symbol detector or a maximum-likelihood sequence detector as known in the art.

One specific realization relates to improving spectral-efficiency in wavelength-division multiplexing systems by using low-complexity duobinary shaping and detection, as described and incorporated by reference in “Approaching Nyquist Limit in Wavelength-Division Multiplexing Systems by Low-Complexity Duobinary Shaping and Detection” by Jianjun Yu and Jianqiang Li.

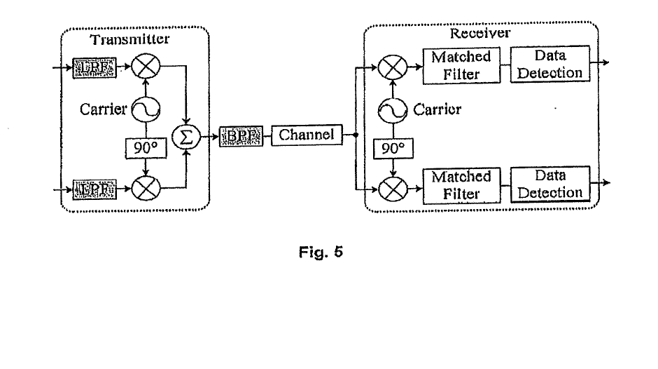

FIG. 5 illustrates a model of a spectrally-shaped QAM system. The spectral shaping can be performed by either two narrowband low-pass filters (LPFs) on the two signal quadratures or a band-pass filler (BPF) in the frequency band. In the context of optical communication systems, the above two approaches correspond to two implementing domains: the electrical domain prior to optical modulation (by either digital or analog means) and the optical domain after optical modulation.

There are a few techniques for detecting an information signal with controlled ISI or a known memory as described by J. G. Proakis in “Digital Communications, Fourth Edition”. One is the symbol-by-symbol suboptimum detector that is relatively simple to implement. This method ignores the inherent memory, thereby suffering from a degraded SNR sensitivity. Another method is MLSD which bases its decisions on the observation of a symbol sequence over multiple successive time intervals as described by J. G. Proakis in “Digital Communications, Fourth Edition”, H. Kobayashi in “Correlative level coding and maximum likelihood decoding,” IEEE Trans. Info. Theory, vol. IT-17, no. 5, pp. 586-94, September 1971, and G. D. Forney, Jr., in “Maximum likelihood sequence estimation of digital sequences in the presence of intersymbol Interference,” IEEE Trans. Info. Theory, vol. IT-18, no. 3, pp. 363-378, May 1972. MLSD makes use of the known memory and minimizes the probability of error. The complexity of MLSD is associated with the involved memory length. For example, if the channel response is shaped to a duobinary pattern that contains a one-symbol memory, the use of MLSD does not impose much computational effort. However if the channel response is shaped to a different pattern that contains a two-symbol memory, for example, then the use of MLSD may impose more computational effort.

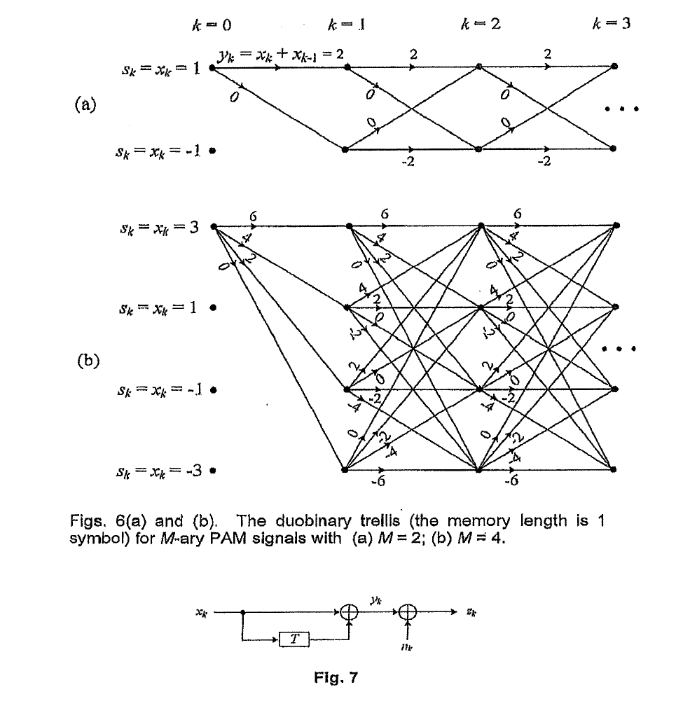

The MLSD can be implemented on the in-phase and quadrature paths of a QAM signal on each of which the signal has an M-ary pulse amplitude modulation (PAM) format. As one type of the channels with memory, the duo-binary shaped channel can be modeled as a finite-state machine that can be represented by a state transition diagram (i.e. a trellis). FIGS. 6(a) and (b) are illustrations of trellises for M-ary PAM for M=2 and 4. The trellises shown are for the duobinary case, however, any class of partial response can be used. The trellis of a duobinary channel containing M states begins with an initial state s₀. sₖ denotes the state in the k^{th} time slot. Because the memory length is one symbol for duobinary, the state sₖ is directly given by the original input xₖ that takes values Xₘ from an alphabet X of M PAM levels (m=1, 2, . . . , M). Because xₖ (and sₖ are exchangeable, xₖ can be used to represent the state for uniformity thereafter. The duobinary-shaped level yₖ=xₖ+xₖ₋₁ is attached to each branch in the trellis. In general, each state has M possible transition paths, and accepts M incoming paths since the time k=2.

FIG. 7 illustrates a simplified model of a duobinary channel corresponding to the trellises of FIGS. 6(a) and (b), where zₖ is the received signal sample in the k^{th} time slot.

It should be understood that the methods and devices of the present Invention may be executed employing machines and apparatus including simple and complex computers. Moreover, the architecture and methods described above can be stored, in part or in full, on forms of machine-readable media. For example, the operations of the present invention could be stored on machine-readable media, such as magnetic disks or optical disks, which are accessible via a disk drive (or computer-readable medium drive). Alternatively, the logic to perform the operations as discussed above, could be implemented in additional computer and/or machine readable media, such as discrete hardware components as large-scale integrated circuits (LSI's), application-specific Integrated circuits (ASIC's), firmware such as electrically erasable programmable read-only only memory (EEPROM's); and the like. Implementations of certain embodiments may further take the form of machine-implemented, including web-implemented, computer software.

While aspects of this invention have been shown and described, it will be apparent to those skilled in the art that many more modifications are possible without departing from the inventive concepts herein. The invention, therefore, is not to be restricted except in the spirit of the following claims.

What is claimed is:

1. A partial response equalizer comprising:
a full response linear equalizing device for equalizing a received signal; and
a partial response post filter for post filtering the equalized signal.

2. The partial response equalizer of claim 1 further comprising a full response carrier recovery device for performing carrier recovery of the signal equalized by the equalizing device.

3. The partial response equalizer of claim 2, wherein the full response carrier recovery device is between the full response linear equalizing device and the partial response post filter.

4. A coherent receiver, comprising:
a receiver front end for converting a received partial response optical signal into a partial response digital signal;
an equalizing device for equalizing the pre-filtered full response digital signal;
a full response carrier recovery device for performing carrier recovery of the signal equalized by the equalizing device; and
a post-filter for post-filtering the signal having undergone carrier recovery by the full response carrier recovery device.

5. The coherent receiver of claim 4 further comprising:
a partial response data detection device for detecting the post-filtered signal.

6. The coherent receiver of claim 5, wherein the partial response data detection device is a symbol-by-symbol detector.

7. The coherent receiver of claim 5, wherein the partial response data detection device is a maximum-likelihood sequence detector.

8. A method comprising:
equalizing a received signal; and
post-filtering the equalized signal.

9. The method of claim 8, further comprising:
performing carrier recovery of the signal.

10. A method for receiving signals in an optical communication system comprising:
converting a received partial response optical signal into a partial response digital signal;
equalizing the pre-filtered full response digital signal;
performing carrier recovery of the signal equalized by the equalizing device; and
post-filtering the signal having undergone carrier recovery by the full response carrier recovery device.

11. The method of claim 10 further comprising detecting the post-filtered signal.

12. The method of claim 11, wherein the detecting comprises symbol-by-symbol detecting.

13. The method of claim 11, wherein the detecting comprises maximum-likelihood sequence detecting.

14. An article of manufacture including a computer-readable medium having Instructions stored thereon, comprising:
instructions for equalizing a received signal; and
instructions for post-filtering the equalized signal.

15. The article of manufacture of claim 14, further comprising instructions for Instructions for performing carrier recovery of the signal.

16. An article of manufacture including a computer readable medium having instructions stored thereon, comprising:
instructions for converting a received partial response optical signal into a partial response digital signal;
instructions for equalizing the pre-filtered full response digital signal;
instructions for performing carrier recovery of the signal equalized by the equalizing device; and
instructions for post-filtering the signal having undergone carrier recovery by the full response carrier recovery device.

17. The article of manufacture of claim 16 further comprising:
instructions for detecting the post-filtered signal.

18. The article of manufacture of claim 17 wherein the detecting comprises symbol-by-symbol detecting.

19. The article of manufacture of claim 17 wherein the detecting comprises maximum-likelihood sequence detecting.
